(19) United States
(12) Patent Application Publication
(10) Pub. No.: US 2003/0069869 A1
(43) Pub. Date: Apr. 10, 2003

(54) Computer aided strategic planning systems and methods

(76) Inventors: Jane Gronau, Amherst, MA (US); Zvi Rozen, Amherst, MA (US)

Correspondence Address: Jane Gronau, 88 Grantwood Drive, Amherst, MA, 01002, US

(21) Appl. No.: 10/263,030

(22) Filed: Oct. 2, 2002

Related U.S. Application Data
(60) Provisional application No. 60/327,250, filed on Oct. 5, 2001.

(51) Int. Cl. G06N 5/02; G06F 17/00

(52) U.S. Cl. 706/46

(57) ABSTRACT

The present invention relates to the field of computer software and hardware generally, and, more particularly, relates to computer-implemented methods and systems for assisting the process of strategic planning. The process provides for application of a computer-based expert system in the articulation of vision, development of goals, detailing of objectives and establishment of action plans for variety of domains applicable to individuals, groups, institutions or businesses. The resulting integrated action plans are automatically assessed for realism, consistency and alignment with consideration to available resources (enablers and constraints) and pre-established rules, axioms, policies and values. Said planning can be accomplished by a single planner, as a collaborative effort by plurality of users, as a decision-making and simulation tool for assessing alternatives or for training purposes

### CROSS REFERENCE TO RELATED APPLICATIONS

This application is based on provisional application serial No. 60/327,250, filed on Oct. 5, 2001

### STATEMENT REGARDING FEDERALLY SPONSORED RESEARCH OR DEVELOPMENT

Not Applicable

### DESCRIPTION OF ATTACHED APPENDIX

Not Applicable

### BACKGROUND OF THE INVENTION

This invention relates generally to the field of planning and more specifically to computer Aided Strategic Planning Systems and Methods Strategic planning is a comprehensive process for determining goals and aligning resources to best achieve them. It appraises the full potential of a business or individual and explicitly links objectives to the actions and resources required to attain them In one form, strategic planning is a systematic process of asking and answering the most critical questions confronting an individual or management team Because the process is hierarchical in nature (typically from the top down), and because it requires developing multiple, detailed action plans informed by resource, constraint, and risk analysis, it is laborious and often tedious in nature In its thoroughness, strategic planning offers the best approach to planning and decision-making. However, that step-by-step meticulousness may mean that organizations and individuals avoid the process altogether or do a less than thorough job Thus, the inherent aspects of strategic planning can work against each other

It is well known that computers, through their capacity to rapidly recall, compare, learn, and process large quantities of information, can expedite overall analysis and support decision making, thereby streamlining an otherwise laborious process Computers can also enable simulation of alternative scenarios by rapidly executing painstaking impact calculations. However, conventional computer systems have not exploited these abilities to provide effective strategic planning tools In particular, conventional systems do not provide electronic strategic planning tools, utilizing artificial intelligence and expert systems, to support a dynamic and integrated planning program for multiple domains, linking vision, goals, objectives and action plans with resources, constraints, and enablers

### PRIOR TECHNOLOGY AND CURRENT STATE OF THE ART

While many and different planning or management tools have appeared in the marketplace in the past few years, recent research shows that business executives rate strategic planning methodologies as the most valuable tool in their workbench. It is the most heavily used of all tools, is always in the top five satisfaction scores and garners the most loyal users. In a recent survey by Bain & Company about management tools and techniques, 90% of the managers interviewed use strategic planning as a tool, with more than 80% indicate satisfaction (“Don't Get Hammered by management Fads,” The Wall Street Journal, May. 21, 2001.) Academic researchers study strategic Planning in business settings extensively, and the results of such studies are published in many popular books and appear regularly in periodicals such as The Harvard Business Review (by the Harvard Business School Publishing) and the Sloan Management Review (by the MIT Sloan Management Review Association) However, no practical solution exists which assists users with the laborious effort that such planning requires The current state of the art in long range planning can be divided into three techniques: manual planning, automated tables and forms, and computerized scheduling and financial planning tools (Financial and Program Management Tools)

1 Manual planning—Almost all the application of strategic planning for personal or business users is done through a manual approach, following a somewhat structured planning methodology of articulating a vision, establishing goals or objectives and developing strategies to achieve these goals. For businesses, there are corporate specialists or consultants that assist with the development of such processes, as well as many guidebooks that offer forms and “step-by-step” advice how to develop a plan The same is true for personal applications where various self-help books exist and personal coaches offer assistance in life goals planning As all practitioners know, the planning process is a lengthy one; its development requires experience and specific abilities and might result in being inaccurate because of errors in assessment of resources. As a result, although it is one of the best management tools to align priorities and make decisions with long-term impact, the planning is done infrequently and is not updated regularly. The present invention is aimed at addressing such critical problems

2 Automated tables and forms—Some tools for the development of long range plans utilize the power of computers as word processors to develop plans and offer users tables and forms which have to be filled up as part of the planning process This technique is helpful in somewhat reducing the amount of work involved and mechanizing the preparation of the plan However, the process is still tedious, inflexible and lacks accuracy to the same degree that manual planning does The abilities of the computer to sort large amount of data, assist in decision making, simplify information and data entry as well as to allow collaborative development of the plan and simulate different alternatives are not utilized The present invention leverages such abilities to offer the user an easy to use, accurate and readily updated planning tool

3 Financial and Program management tools—There are a large number of computerized tools used by individuals, groups, and institutions/businesses for financial planning and program management A few of the most common and readily available of such tools are Quicken® (registered trademark of Intuit, Inc) and MS Money® or MS Project® (registered trademark of Microsoft Corp) These tools, aimed at either individual users or businesses, are tactical, narrow in their application and are specific for financial planning and monitoring or project planning, task breakdown and scheduling None of these tools offer the “top-down” planning which strategic plans require, none addresses multiple varied constraints, or is flexible enough to be used in a wide range of scenarios, and none applies planning/decision criteria based on multiple rules, axioms, and priorities in a number of planning domains This invention addresses such need

Several inventions to apply computers to planning needs have been proposed However, none addresses nor solves the problems in a manner similar to the present invention For example, U.S. Pat. No. 5,963,910 to Ulwick (1999) for computer based process for strategy evaluation and optimization based on customer desired outcomes and predictive metrics, offers a method for defining a plurality of strategic options aimed at satisfying customer desired outcomes. The patent suggests a means for quantifying the degree to which each of said strategic options satisfy said customer's desired outcome Such evaluation can yield an option which best satisfies the desired outcome This method differs dramatically from the present invention. We offer a tool to assist in developing a strategic plan, using the computer to assist the planer in a step by step process and evaluating, on an ongoing basis, the realism of the plan with regard to available resources and established values/axioms/rules, rather than attempting to select from specified options an optimized plan based on a final criteria (customers' desires)

U.S. Pat. No. 6,002,863 to Sheer et al (1999) discloses a computer implemented method and system for simulating strategic planning and operations using operations control language (OCL ) The language proposed has the characteristics of expressing a target, a condition, an integer hierarchical priority and penalty or value. Our invention does not impose a specific programming language but rather the application of an expert system methodology to assist planners with the development of the strategic options and utilize the computer and the embedded expert facility to a) simplify data entry through use of “machine learning”, b) provide on-going verification of realism of each and all action plans through accounting of utilized versus available resources, c) indicate conflicts or discontinuities in the plan, and d) identify need for re-plan once status input is identified as creating a condition of plan failure

U.S. Pat. No. 5,331,545 to Yajima et al (1994) describes a system and method for planning support Such system which includes workstation, operator interface, planning process feature and data files and server, is characterized by a stored planner model with plurality of planning actions, and time sensitive data flow between the various planning actions. This proposed planning support system and method addresses the tactical planning needs in a business enterprise and is significantly different from the present invention that is aimed at assisting in the development of a strategic plan that supports a vision of the future for individuals, groups, institutions and businesses

The invention disclosed herein improves upon background methods, overcoming the limitations and shortcomings of the prior art such as a tedious and inflexible process which does not utilize currently available computerized tools, lack of integration of plans in plurality of domains using a single database, lack of accuracy in planning due to insufficient attention to available resources, inability to provide for an efficient group/team planning, and more Additional objectives and advantages of the present invention are detailed in the body of this disclosure.

### OBJECTS AND ADVANTAGES

The primary object of the invention is to provide an effective method of using a computer processor to develop a long range/strategic plan through the execution of a sequence of steps in a process, connected through a relational database and computerized expert system, wherein the process comprises the steps of identifying a vision in at least one domains, identifying goals and objectives that support the vision, developing action plans and resources required to implement such plans, and assessing consistency, pragmatism and alignment of actions.

Another object of the invention is to provide for the allocation of available resources with a pre-identified set of priorities/rules/policies/axioms and automate the identification of conflicts or discontinuities in the use of such resources.

Yet another object of the invention is development of planning steps assisted by any of an electronic coach, embedded tools and a computerized expert system that perform any of data transfer, comparison and identification of discontinuities, automatically, without interference by a human user.

Another object of the invention is to offer a computerized platform for multiple users to accomplish a joint planning or be trained in long range planning and decision-making.

An additional object is to carry out status updates and reporting of progress

Other objects and advantages of the present invention will become apparent from the following descriptions, taken in connection with the accompanying drawings, wherein, by way of illustration and example, an embodiment of the present invention is disclosed

### SUMMARY OF THE INVENTION

The present invention provides electronic strategic planning tools, using artificial intelligence and expert systems, to support a dynamic and intelligent planning program linking vision, goals, objectives and action plans with resources, constraints, and enablers One practice of the invention, referred to herein as Computer Aided Strategic Planning (CASP), supports a structured planning process Applying the program, the user presets rules and values within the program and then proceeds through a sequence of steps that result in (1) articulation of a vision, (2) development of goals in multiple domains, (3) definition of objectives, (4) selection of strategies, and (5) identification of action items. For each action item, the program assists the user to identify quantitative and non-quantitative resources including costs and time required for completion. These items are then compiled with all the resources required for other tasks, and measured against available resources Feasibility is determined for each action item, and conflicts are identified. Embedded tools support calculations and determination of input information. Through a calendar utility, the system also helps the user track milestones. As new information is entered, such as completion of action items, revision of goals, or change in resources, the computer aided strategic planning program automatically updates the plan across the domains, asking questions of the user and conveying impact information through its reporting function A time-phased list of tasks, progress measurements, and reports continually encourage the user to stay on track and on target, or enable the user to enter changes at any level.

The invention thus provides numerous advantages, including automation of the laborious strategic planning process, the ability to simulate strategic alternatives, develop long-range plans, verify their feasibility in concert with available resources, and maintain a continually updated action plan in an effective and supportive way

Features of a computer software product constructed in accordance with the present invention include the following.

Sound planning tools.

Vision, goals, and objectives development

Action plan development (utilizing embedded tools)

Computer assisted decision-making (simulations/“what if” scenario tests)

Values/priorities alignment

Systematic resource allocation (realistic/priorities based)

User friendly environment.

Measurement and assessment

Reports generation

User learning (training for planning and decision making)

Help/Support

Integrated events calendar.

“My Notebook”

Expert advice (on-line/e-mail)

Communication Coach

Multi-user operation

Advanced Computing.

Open architecture

Artificial intelligence (rule-based and machine learning)

Adaptive and robust user interface

Bundling interface with off the shelf tools

Data storage/case library

### DRAWINGS

### DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

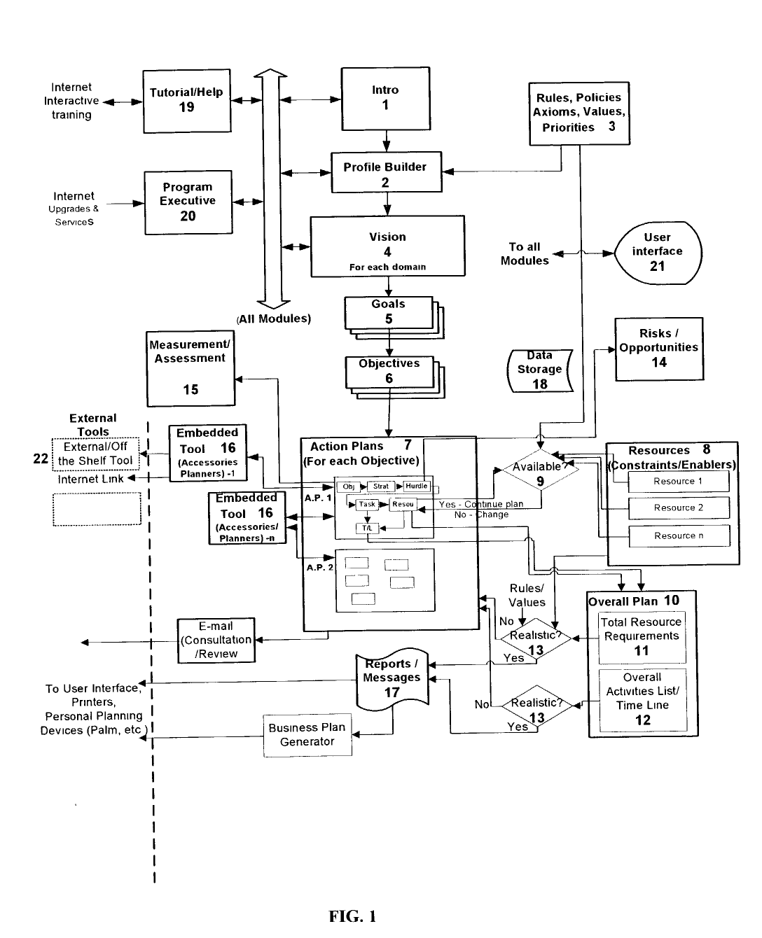

FIG. 1 is an overall block diagram illustrating the Computer Aided Strategic Planning (CASP) process

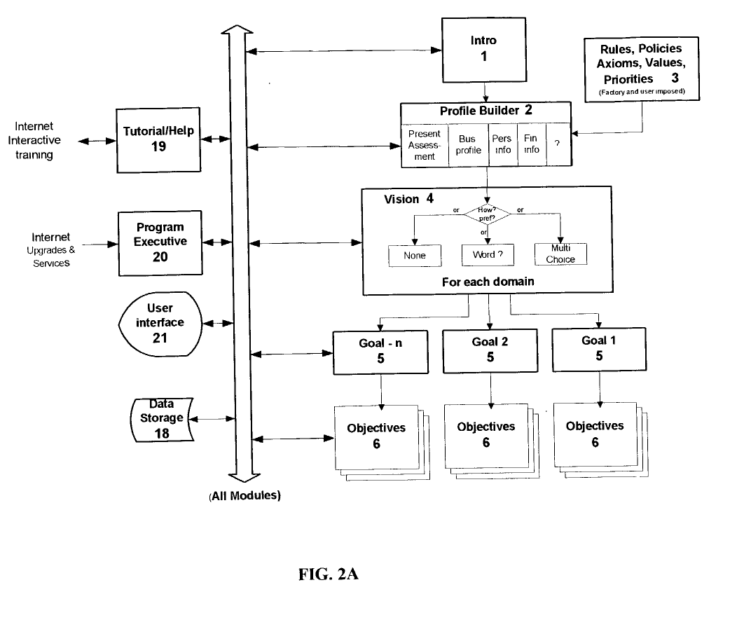

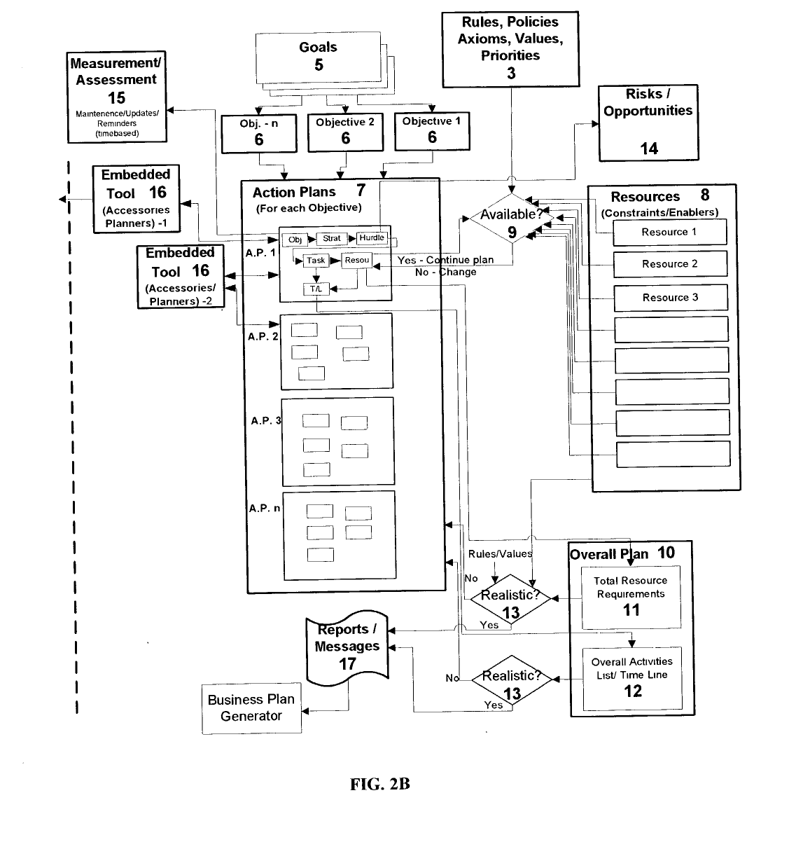

FIGS. 2A and 2B are flow diagrams illustrating the structure of the CASP process in two sections

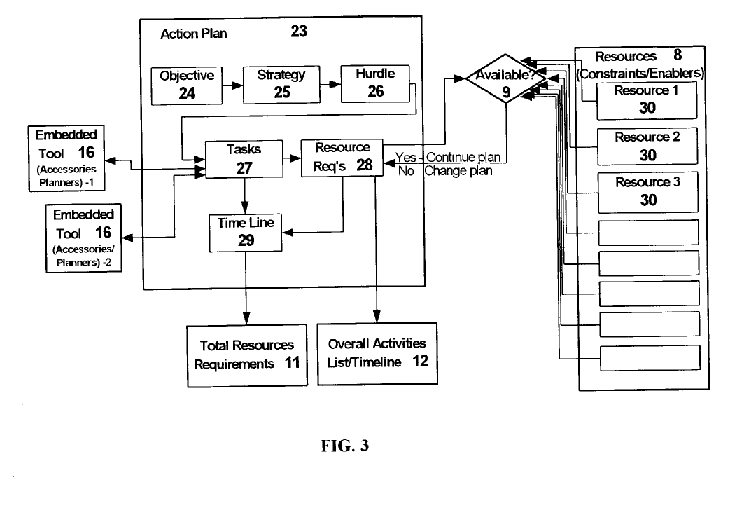

FIG. 3 is a flow diagram illustrating the process of developing an Action Plan and validation of resources in accordance with the invention

### REFERENCE NUMERALS USED IN THE DRAWINGS

| | |
|---|---|
| 1 | Introduction |
| 2 | Profile Builder |
| 3 | Rules, Axioms, Values, |
| | Policies, and Priorities |
| 4 | Vision |
| 5 | Goals |
| 6 | Objectives |
| 7 | Action Plans |
| 8 | Resources |
| | (Constraints/Enablers) |
| 9 | Question of Availability |
| 10 | Overall Plan |
| 11 | Total Resource Requirements |
| 12 | Total Timeline/Activities List |
| 13 | Question of Consistency and |
| | pragmatism |
| 14 | Risks/Opportunities |
| 15 | Measurement/Assessment |
| 16 | Embedded Tools (Accessories |
| | & Planners) |
| 17 | Reports/Messages |
| 18 | Data Storage |
| 19 | Tutorial/Help |
| 20 | Program Executive |
| 21 | User Interface |
| 22 | Expert Advice (e-mail) |
| 23 | Action Plan |
| 24 | Objective |
| 25 | Strategy |
| 26 | Hurdles |
| 27 | Tasks |
| 28 | Resource Requirements |
| 29 | Timeline |
| 30 | Resource |

### DETAILED DESCRIPTION OF THE PREFERRED EMBODIMENTS

Detailed descriptions of the preferred embodiment are provided herein It is to be specific understood, however, that the present invention may be embodied in various forms. Therefore, details disclosed herein are not to be interpreted as limiting, but rather as a basis for the claims and as a representative basis for teaching one skilled in the art to employ the present invention in virtually any appropriately detailed system, structure or manner

A. Introduction

In one practice of the invention, which will next be described, the invention is embodied in a computer Assisted Strategic Planning (CASP) application that can reside, for example, in the memory of a computer with a Pentium I or higher processor, connected to a monitor for user information and display, and to printers or other computer output devices. Optionally, the computer can be connected to the World Wide Web (Internet) for exchange of information with resources in the public domain or for presenting questions to a network of specialists. Computer Aided Strategic Planning is based on a detailed process described below in Section B In one embodiment, it utilizes an effective but simple Graphic User Interface, “machine learning” to adapt the program to a specific user as detailed in the following section, and an expert system as detailed herein Upon completion of the planning phase, CASP, through its calendar utility, helps the user track milestones in an overall integrated plan As new information is entered, such as completion of action items, revision of goals, or change in resources, CASP automatically updates the plan across the domains, asking questions of the user and conveying impact information through its reporting function. A time-phased list of tasks and progress measurements continually encourage the user to stay on track and on target.

Machine learning can be used to minimize the load on the user and to expedite the process of developing the plan. It is an adaptive, interactive interface system that stores information from previous contacts with a single user in a case library, basing on it the order of suggestions or questions presented to the user, and recommending options that the user might find attractive Conventional tools for machine learning can be readily adapted to the present application Machine learning thus provides an appropriate technology for accelerating and simplifying the user interface—key elements in the future success of CASP.

In the illustrated embodiments of the invention, the Computer Aided Strategic Planning expert system uses the knowledge and inference procedures of an expert strategic planner to assist the user in developing a strategic plan. The computer expert system performs the following tasks

Interpretation—inferring situation description from user input

Prediction—inferring likely consequences of a given situation.

Diagnosis—inferring potential problem from data provided by the user.

Prescription—suggesting potential remedies for a potential problem

Design—suggesting possible actions

Planning—suggesting generalized or generic plans for a given situation

Monitoring—comparing status to planned outcomes.

Control—governing overall system behavior.

Instruction—diagnosing and guiding user behavior

Rules-based programming can be used as a technique for developing the expert system described herein In such programming, rules are used to present heuristics that specify a set of actions to be performed for a given situation. A rule is composed of an “if . then” statement. The “if” portion of the rule consists of a series of patterns that specify the fact (or data) which causes the rule to be applicable. The process of matching facts to patterns is called pattern matching. The expert system provides the mechanism, called the inference engine, which automatically matches facts against patterns and determines which rules are applicable. The “if” portion of a rule is applied in relation to existing facts (current situation, available resources, conflict with enablers or constraints, etc) The “then” portion of a rule is a set of actions to be executed when the rule is applicable. In CASP, the actions identified by the inference engine will be in the form of generic suggestions to the user and not execution of independent actions by the computer The result of the user response to the suggested action can affect the list of rules by adding or removing facts.

There are a number of successful expert system tools, such as CLIPS (a widely used, publicly available expert system development environment written in C), that are designed to assist in the development of expert systems and greatly reduce the attendant effort and cost Such a tool can be readily adapted for the implementation of the CASP system of the present invention.

B. The CASP System

FIG. 1: Is used to illustrate the overall structure of CASP and its details are included in the description of FIGS. 2A and 2B herein

FIGS. 2A and 2B: Referring now to the block diagram of FIGS. 2A and 2B, the Computer Aided Strategic Planning architecture depicted therein begins with an introduction (1) and is followed by the development of a profile of the user (individual, business or any organization) The profile builder (2) includes information such as financial, personal or business, available resources and possibly an assessment of present situation relative to customers, competition, markets, relationships, etc In addition to the profile builder, the user is asked (3) to define values, priorities, policies, and rules that should be applied to the planning These are added to the factory established rules and axioms

The structured planning process continues to a vision development step (4) utilizing multiple input options. The user is also able to skip this step and continue to the identification of goals (5) relative to application specific domains The user then identifies objectives (6) for each of the goals. Once objectives are identified, the user proceeds to develop action plans (7) for each, as detailed in FIG. 3.

In order to assist the user with the development of the action plan, there are a number of embedded tools (16) resident in the program that include calculators, accessories, planners, questionnaires and links both to external tools (22) for export/import of data and to the internet for available information. Once all the action plans are developed and an assessment of available resources (8) is completed by the availability utility (9), an overall plan (10) is constructed that includes the total resource requirements (11) and an overall activities list/timeline (12). These two elements of the overall plan are verified for consistency and pragmatism (13) against the rules, values, priorities, policies, and axioms identified in the rules database (3).

The process utilizes the rules based expert system detailed above and in a manner similar to that utilized in addressing the question of availability illustrated in the action plan development detailed in FIG. 3. An indication of conflict, discontinuity or violation of a rule posts a flag to the operator and an action is required in the form of a plan alteration, change to a rule, or a user override, that is, a decision to ignore the computer's suggestion With the flag of a problem, the expert system may present suggestions for ways to resolve such conflict If no conflict is identified, the plan is accepted and multiple options for reports, messages and data export to printers, personal planning devices or other programs (17) are available to the user As action plans are developed, and hurdles identified, a list of risks and opportunities is assembled (14) to notify the user of areas that require attention. During the update and maintenance phase of the program, as action plans are completed and recorded, a measurement/assessment function (15) keeps track of the status of the activities and the achievement of goals, summarizing such achievements and providing the user assessment of tasks, objectives and goals and reminders of open items

A data storage function (18) keeps a time-tagged record of profile, resources and activities thus providing a history file of information for future reference. Further help is provided by a tutorial/help facility (19) that coaches the user and provides assistance throughout the process of the strategic plan development

Overall elements of the program include the executive (20) that times, watches, controls revisions and provides other services to the different modules, as well as the user interface (21). The user interface can be a conventional Graphic User Interface (GUI) utilizing familiar formats such as Windowsg®, HTML, multiple choice, and graphic symbology that are intuitive and easy to use

The CASP system of the invention can apply current (or developing) multimedia technologies to streamline the interface, easing significantly the use of the program In the embodiments described herein, the user can be guided through a ‘conversation’ with the program, has the flexibility of choosing the method of entering data, and is prompted to take additional steps or reconsider decisions based on the rules embedded in the expert system. The described GUI makes the CASP learning curve short and steep, and the feel and functionality of the program is fast, efficient and enjoyable

FIG. 3. Referring now to FIG. 3, it will be seen that for each objective (24), a strategy (25) for achieving that objective is developed and hurdles (26) that are being considered are listed. The strategy is then broken into activities or tasks (27), and resource requirements (28) to accomplish the tasks are identified

The resources required can be quantitative or qualitative, and the user is instructed, through data input limitations, to use the same categories used in the profile builder and the creation of the resources (8) database.

Throughout the identification/allocation of resources to each task, the computer expert system detailed above assesses the availability of such resources and the alignment of the plan with the previously identified rules, priorities, values and axioms This assessment is executed in the “availability” utility (9)

In a manner similar to the process detailed in FIG. 2 module (13) above, an indication of conflict, discontinuity or violation of a rule posts a flag to the operator and an action is required in the form of plan alteration, change to a rule, or a user override, that is, a decision to ignore the computer's suggestion With the flag of a problem and dependent on the type of conflict, the expert system may present at this point suggestions for ways to resolve such conflict The remaining available resources in the database are updated for availability consideration in future action plans

C. Conclusion

The process for computer aided strategic planning detailed in this invention can be utilized in multiple applications, providing users an effective way to define long range plans, aligned to a consistent vision while allocating available resources to each of the action plans in accordance with clearly defined set of priorities or rules Additionally, the invention provides the user with listing of time-phased tasks, a summary of all available and future required resources, thus supporting the implementation of such plan Furthermore, a method to track previously developed plans and assess success or failure in concise and easily identified ways is included

Although the description above contains many specific details, these should not be construed as limiting the scope of the invention but as merely providing illustration of some of the presently proffered embodiment of this invention For example, the long range plan can be aimed at addressing only one area of interest, in which case, the invented process and the utilization of such tool can be simplified and reduced to one, vision, one goal, one resource, etc Additionally, some modules in the process can be minimized or even eliminated if necessitated by the application, without changing the scope of this invention. Thus, the scope of the invention should be determined by the appended claims rather than by the examples given above

While the invention has been described in connection with a preferred embodiment, it is not intended to limit the scope of the invention to the particular form set forth, but on the contrary, it is intended to cover such alternatives, modifications, and equivalents as may be included within the spirit and scope of the invention as defined by the appended claims

What is claimed is

1. A method of using computer capability to develop a long range/strategic plan through executing a sequence of steps in a process, connected through a relational database and computerized expert system, wherein the process comprises the steps of: identifying a vision in at least one domains, identifying goals and objectives that support the vision, developing action plans and resources required to implement such plans, and assessing consistency, pragmatism and alignment of actions and allocation of resources with a pre-identified set of priorities/rules/policies/axioms, wherein development of the steps is assisted by any of an electronic coach, embedded tools and a computerized expert system that perform any of data transfer, comparison and identification of discontinuities, automatically, without interference by a human user.

2. The method of claim 1 wherein the sequence of steps can be modified by the user and steps can be omitted, whereby the user is allowed to proceed in a user-selectable order of personal preference, and wherein the computer
a) keeps track of steps not addressed, and
b) attempts to automatically create notices of missing information, and present such notifications to the human user for approval

3. The method of claim 1 wherein a consideration of resources availability is applied to numerical and non-numerical resources description.

4. The method of claim 1, further comprising a planning process based on rules, pre-established priorities, and values defined by the user, which are enforced by a computerized expert system.

5. The method of claim 1, further comprising integration of steps through the utilities of the computer, to enable representation of dependencies and consideration of relationships between planning steps.

6. The method of claim 5, wherein the utilities include any of a relational database and an expert system.

7. The method of claim 1, further comprising the step of taking into consideration multiple contributors or planners for the same plan with the same rules and constraints

8. The method of claim 1, further comprising the step of configuring a planning tool that can be used to generate a business plan derived from long-range goals and consistent with available resources

9. The method of claim 1, further comprising the step of configuring a training tool for one or plurality of individuals in planning, decision-making and the development of common operational understanding or requirements
